(19) United States
(12) Patent Application Publication
(10) Pub. No.: US 2013/0072977 A1
(43) Pub. Date: Mar. 21, 2013

(54) TEETHER

(71) Applicants: Marcel Van Engen, Eindhoven (NL); Peter Smith, Drachten (NL)

(72) Inventors: Marcel Van Engen, Eindhoven (NL); Peter Smith, Drachten (NL)

(73) Assignee: KONINKLIJKE PHILIPS ELECTRONICS N.V., EINDHOVEN (NL)

(21) Appl. No.: 13/640,791

(22) PCT Filed: May 31, 2011
(86) PCT No.: PCT/IB2011/052389

§ 371 Date: Oct. 12, 2012

(30) Foreign Application Priority Data
Jun. 7, 2010 (EP) 10165031.5

(51) Int. Cl. A61J 17/00

(52) U.S. Cl. CPC A61J 17/00
USPC 606/235

(57) ABSTRACT

A teething device comprising a shield connected to a gum soothing portion formed from a frame is disclosed. The frame is configured to locate underneath a lip and against a gum of an infant when in use. Furthermore, the frame is shaped so as to conform to an infant's gumso as to produce a massaging effect on said gum.

### FIELD OF THE INVENTION

Babies and toddlers suffer from pain during teething. To alleviate the pain babies can bite on a teether which relieves pain by activating biting behavior. There are various types of teethers, for example, some teethers are in the shape of toys and rings. However, an apparent problem with these is that they do not remain in the mouth of the baby due to their shape. To overcome this, there are teethers similar to a dummy or a pacifier.

### BACKGROUND OF THE INVENTION

For example, US20050119699 discloses a teether comprising an arched portion attached to a shield. The arched portion is positioned between the dental arches of the baby so that during biting it engages with the gum area through which the teeth erupt. The shield prevents the baby from accidentally swallowing the teether. To further reduce the pain, the teether disclosed in US20050119699 comprises a vibrating feature so as to have a massaging effect on the baby's gum. It is known that massaging the gum during teething significantly alleviates the pain. However, a disadvantage of the disclosed teether is that it requires power in the form of a battery in order to vibrate and so massage the gum.

An alternative approach involves a parent using their fingers to gently massage the gum of a baby in order to reduce the pain, however this is not a feasible long term solution. Therefore, there is a desire to provide a teether configured to remain in the mouth of an infant and which also has a massaging effect on the gum.

### SUMMARY OF THE INVENTION

The present invention seeks to provide a device for relieving teething that overcomes or substantially alleviates the problems mentioned above.

According to the present invention, there is provided a teething device comprising a shield connected to a gum soothing portion formed from a frame configured to locate underneath a lip and against a gum of an infant when in use, the frame being shaped so as to conform to an infant's gum so as to produce a massaging effect on said gum, wherein the frame is tubular in shape.

Preferably, the frame comprises a section which conforms to the gum of an upper or lower dental arch when in use.

In one embodiment, the frame is continuous and comprises an upper and a lower section which conform to the gum of an upper and lower dental arch respectively, said sections being connected via intermediate sections.

In an alternative embodiment, the frame surrounds an inner structure which is connected to the shield by a connector. The inner structure may be a plate such that the frame is located at the periphery of said plate.

Conveniently, the inner structure is formed with a teat so that motions applied to the teat are translated to the frame so as to increase the massaging effect.

The frame may be solid or hollow.

In the case of a hollow frame, the frame may be filled with a gas or a liquid which may be cooled prior to use so as to have an additional soothing effect.

### BRIEF DESCRIPTION OF THE DRAWINGS

Embodiments of the present invention will now be described by way of example only, with reference to the accompanying drawings, in which:

FIG. 1 shows a perspective view of a device according to the present invention, the device being formed with a gum soothing portion; and

FIG. 2 shows a perspective view of another embodiment according to the present invention, where the device has a gum soothing portion combined with a teat.

### DETAILED DESCRIPTION OF THE EMBODIMENTS

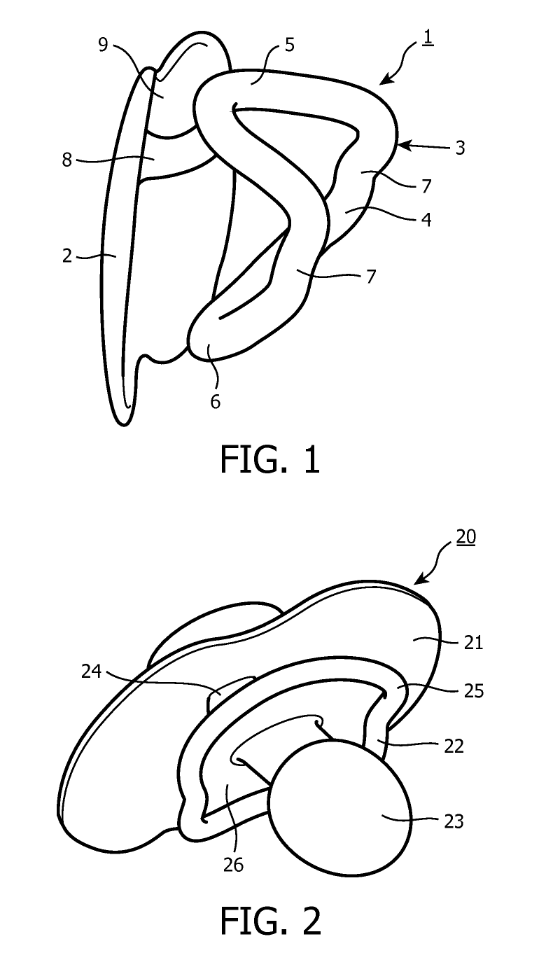

Referring now to the drawings, there is shown in FIG. 1 a device for relieving pain in infants caused by teething. The device 1 comprises a shield 2 connected to a gum soothing portion 3 configured to be located underneath the lip and against the gum so that it has a massaging effect on the gum.

As illustrated in FIG. 1, the shield 2 is curved so as to follow the contour of an infant's mouth when in use. The main functions of the shield 2 are to prevent the device 1 from being swallowed and for holding the gum soothing portion 3 in position. As can be appreciated from FIG. 1, the gum soothing portion 3 comprises a continuous frame 4 of tubular configuration which follows the contour of the gum line of an infant. The frame 4 has an upper and a lower section 5, 6 which is connected by intermediate sections 7. When the device is in use, the upper and lower sections 5, 6 are positioned above the gum line and follow the outer surfaces of the dental arches underneath the lips so that they engage with the gum. The gum soothing portion 3 is preferably made out of silicon or thermoplastic elastomers (TPEs).

The gum soothing portion 3 is connected to the shield 2 by a connector 8 which extends from an inner surface 9 of the shield 2 and curves upwards towards the gum soothing portion 3. The connector 8 creates a space between the gum soothing portion 3 and the shield 2, and it is curved so as to allow a front portion of the lip to drop down over the gum soothing portion 3 when in use so that the gum soothing portion 3 runs continuously beneath the lip against the gum. It should be understood that the connector 8 may alternatively extend between the shield 2 and the lower section 6 of the gum soothing portion 3. Then again, the device 1 may be provided with two connectors; one for the upper section 5 and another for the lower section 6 thereby rendering the intermediate sections 7 unnecessary. In this embodiment, the frame may be discontinuous, for example, the device may only be provided with the upper and/or lower portions.

When the device 1 is positioned in an infant's mouth as described above, a gentle pressure is applied to the outer gum area either by the fit of the frame 4 itself and/or by the pressure of the lips applied to the frame 4. Movements of the mouth and lips in combination with the gentle pressure causes the gum soothing portion 3 or the frame 4 to engage with the gum area in which it is in contact so as to have a massaging effect. The massaging of the gum will stimulate the nervous system and so alleviate and soothe pain associated with teething.

In the embodiment described with reference to FIG. 1, the frame 4 is of a solid tubular structure. However, in another un-illustrated embodiment, the frame is hollow and filled with air. Alternatively, the hollow frame may be filled with a gel or a liquid which may be cooled prior to use by placing the device in a cooled space, for example a fridge. The cooling sensation against the gum will provide additional soothing effect.

An alternative embodiment is shown in FIG. 2, in which the device 20 comprises a shield 21 connected to a gum soothing portion 22 and a teat 23. Similarly to the embodiment described with reference to FIG. 1, the shield 21 is curved so as to follow the contour of an infant's mouth. The gum soothing portion 22 is connected to the shield 21 via a connector 24 and as can be appreciated from FIG. 2, the gum soothing portion 22 comprises a continuous frame 25 having a tubular configuration which surrounds an inner structure in the form of a plate 26. The plate 26 is further provided with the teat 23.

The frame 25 and the plate 26 are curved so that they follow the curvature of the dental arches. When in use, the frame 25 is located above the gum line against the front side walls of the dental arches underneath the lips and so engages with the outer gum area. The pressure of the lips applied to the frame 25 causes a gentle pressure to be applied to the outer gum area. As the infant sucks on the teat 23, further pressure is applied to the gum and any movements of the teat 23 are translated to the frame 25 such that it has a massaging effect on the gums. The massaging of the gum will stimulate the nervous system and so alleviate and soothe pain associated with teething.

It should be understood that the teat 23 is optional, as in an alternative un-illustrated embodiment the device comprises the shield 21 and the gum soothing portion 22 as described with reference to in FIG. 2 however without the teat 23. In this embodiment, movements of the mouth and lips provide the massaging effect of the frame 25 on the gums.

It is also envisaged that the device 20 described with reference to FIG. 2, may comprise a solid or a hollow frame 25. In the case of a hollow frame, it may either be filled with gas, gel or liquid. The gel or liquid may be cooled prior to use by placing the device in a cooled space, for example a fridge. The cooling sensation against the gum will provide additional soothing effect.

It is also to be appreciated that the frame does not have to be continuously formed around the plate as partially configured frames also fall within the scope of the present invention. Additionally, the plate may be replaced by an alternative structure, for example, the device described with reference to FIG. 2 may be formed with a partial plate or bars extending between the frame and the connector.

The above described embodiments may further be provided with a handle 27 as shown in FIG. 2, so as more easily insert and remove the device from the baby's mouth.

Although embodiments of the invention have been shown and described, it will be appreciated by those skilled in the art that the foregoing description should be regarded as a description of preferred embodiments only and that other embodiments that fall within the scope of the appended claims are considered to form part of this disclosure.

1. A teething device comprising a shield connected to a gum soothing portion formed from a frame configured to locate underneath a lip and against a gum of an infant when in use, the frame being shaped so as to conform to an infant's gum so as to produce a massaging effect on said gum, wherein the frame is tubular in shape.

2. A device according to claim 1, wherein the frame is hollow.

3. A device according to claim 2, wherein the hollow frame is filled with a gas or a liquid which is to be cooled prior to use so as to have an additional soothing effect.

4. A device according to claim 1, wherein the frame is solid.

5. A device according to claim 1, wherein the frame comprises a section which conforms to the gum of an upper or lower dental arch when in use.

6. A device according to claim 1, wherein the frame is continuous and comprises an upper and a lower section which conform to the gum of an upper and lower dental arch respectively, said sections being connected via intermediate sections.

7. A device according to claim 1, wherein the frame surrounds an inner structure which is connected to the shield by a connector.

8. A device according to claim 7, wherein the inner structure is a plate such that the frame is located at the periphery of said plate.

9. A device according to claim 7, wherein the inner structure is formed with a teat so that motions applied to the teat are translated to the frame so as to increase the massaging effect.
